(19) United States
(12) Patent Application Publication
(10) Pub. No.: US 2004/0204773 A1
(43) Pub. Date: Oct. 14, 2004

(54) System and method for home delivery service

(75) Inventor: Sook-Young Kim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/760,395

(22) Filed: Jan. 21, 2004

(30) Foreign Application Priority Data
Jan. 21, 2003 (KR) 10-2003-0004127

(51) Int. Cl. G06F 17/60

(52) U.S. Cl. 700/9; 705/1; 709/208

(57) ABSTRACT

The present invention is a home delivery service system and a method thereof. The home delivery service system is provided with a mailbox connected to an external device, controlling opening and closing of a lock formed at a door of the mailbox in accordance with a signal received from the external device. The system receives a set of figures input through a key input unit of a body of the system and transmits the input figures to the external device. The home delivery service system also includes a web service provider, a storage unit for storing a password, and a data processing/authentication unit performing a communication with the mailbox. When the set of input figures transmitted to the mailbox match the password stored in the storage unit, an open-signal is transmitted to the mailbox indicating to unlock the lock.

This application claims benefit under 35 U.S.C. § 119 from Korean Patent Application No. 2003-4127, filed on Jan. 21, 2003, the entire content of which is incorporated herein by reference.

### BACKGROUND

1. Field of the Invention

The present invention relates to a home delivery service system, and more particularly, it relates to a home delivery service system which uses a home gateway enabling the delivery to be received by an intended receiving person for certain even in the absence of the receiving person, and a home delivery method thereof.

2. Description of the Related Art

Generally, gateways are used to connect networks of different communication protocols. Among these, a home gateway is used to link a home network and external communication networks.

The home network consists of information system devices such as a personal computer and a facsimile, A/V devices such as TV, set-top box and DVD, control system devices such as coffee maker, electronic cooker and a refrigerator, and dummy devices such as a remote controller and an interphone. According to the categories that these devices belong to, the devices are connected to sub-nets such as telephone line, wireless LAN, Bluetooth, USB (universal serial bus), IEEE1394 and power cord.

Applications of such home gateway existing between the home network and the external communication network have been diversified to various areas such as electronic unmanned security and home automation for example, and they still continue to develop. Against this backdrop, the home gateway may be applied to the home delivery service and provide more convenience. That is, if a delivery can be safely received through a receiving system, it will be very convenient especially when there is no person currently waiting inside the house.

Herein, the ‘home delivery service’ refers to a freight/delivery service which delivers usually a number of small-size goods to a requested place for a predetermined delivery fee according to an order placed by the customers such as an individuals or a company. In order to place a delivery order to a service company, a customer uses a telephone or Internet website. The customer then gives the service company the information about the location where he/she is and the type of the delivered goods with the name of the intended receiver and the location where the receiver is. After going through this process, a deliveryman visits the customer and attempts to deliver, or pick up, the parcel.

However, the problem arises when the deliveryman arrives at the door of the intended receiver and there are no people inside the house. In the past, this problem was not significant, because there were almost always housewives who can answer the visit. However, as society has developed and became more diversified, more and more women had found their careers outside the houses and families have been cut down into nuclear family units. The deliveryman is always pressed for time and thus he/she does not have time to wait for anyone of the house to get home. On the receiving person's side, he or she also has the inconvenience because he/she could not have the parcel timely. Some people order the goods to be delivered to the workplace where he/she works during the daytime. However, it is practically impossible to do so all the time.

The inventor accordingly suggests a home delivery service system which uses a home gateway installed in the houses so that the goods can be delivered or retrieved safely and for certain even when there are no people inside the houses.

### SUMMARY

An aspect of the invention is to solve at least the above problems and/or disadvantages and to provide at least the advantages described hereinafter.

It is another aspect of the present invention to provide a home delivery service system which enables a successful delivery of the goods even when there are no people inside an intended house when the delivery arrives, and a method thereof. It is also noted that although the following discussion is directed to the delivery of a parcel, it is contemplated that the invention discussed herein can equally be applied to the pick-up of a parcel. Namely, it is contemplated that the present invention can be used by the customer to schedule a pick-up of a parcel. For example, when either returning or shipping a parcel.

In order to accomplish the above aspects and/or other features of the present invention, there is provided a home delivery service system, which is provided with a mailbox which is capable of connecting to an external device, controlling opening and closing of a lock formed at a door of the mailbox in accordance with a signal received from the external device, and receiving a set of figures input through a key input unit of a body of the system and transmitting the input figures to the external device. The home delivery service system includes a web service provider for connecting to an external communication network, and registering therein a password transmitted from a communication device connected to the external communication network, a storage unit for storing the password, and a data processing/authentication unit performing a communication with the mailbox, and when the set of input figures transmitted to the mailbox match the password stored in the storage unit, transmitting an open-signal to the mailbox indicating to unlock the lock.

Further provided is an electronic mail transmitting unit for sending out an electronic mail to the communication device based on a response signal from the mailbox.

The mailbox is opened in accordance with the open-signal as received for the parcel to be placed in the mailbox, and then closed again after the parcel is placed. Additionally and alternatively, the mailbox is opened in accordance with the open-signal for a parcel to be retrieved from the mailbox, and closed after the parcel has been removed.

When the locking device is closed, the mailbox transmits a close-signal of the lock to the data processing/authentication unit, and the data processing/authentication unit controls the electronic mail transmitting unit in accordance with the close-signal as received so that an electronic mail can be sent out to the communication device to inform that the parcel has been delivered or taken out.

The mailbox includes a data converting unit for performing communication with the data processing/authentication unit, a locking device for controlling opening and closing of the lock, an input unit for being inputted with the set of input figures, and a control signal converting unit for interpreting and interfacing signals between the locking device and the input unit on the one hand and the data converting unit on the other hand.

The mailbox and the data processing/authentication unit is connected through a power line, to carry out a power line communication (PLC).

According to the present invention, a home delivery service method includes the steps of a) preparing a mailbox, which can connect to an external device, control opening and closing of a lock formed at a door of the mailbox in accordance with a signal received from the external device, and receive a set of figures input through a key input unit of a body of the system and transmit the received figures to the external device, b) connecting to an external communication network and registering a password transmitted from a communication device connected to the external communication network, c) storing the registered password, and d) when the set of input figures transmitted to the mailbox match the password stored in the storage unit, transmitting an open-signal to the mailbox indicating to unlock the lock.

Further provided is the step of sending out an electronic mail to the communication device based on a response signal from the mailbox.

The mailbox is opened in accordance with the open-signal as received for the parcel in the mailbox to be delivered or taken out, and then closed after the taking or delivery of the parcel.

When the lock is closed, an electronic mail is sent out to the communication device to inform that the parcel has been taken out.

### BRIEF DESCRIPTION OF THE DRAWINGS

The above objects and other features of the present invention will become more apparent by describing in detail an embodiment thereof with reference to the attached drawings, in which:

FIG. 1 is a view illustrating the construction of a home delivery service system according to an embodiment of the present invention;

FIG. 2 is a block diagram of a mailbox of FIG. 1;

FIG. 3 is a flowchart illustrating a method of operating the home delivery service system according to an embodiment of the present invention; and

FIG. 4 is a view schematically illustrating data signal transmission among a communication device, a home gateway and a mailbox.

### DETAILED DESCRIPTION OF THE INVENTION

Hereinbelow, a home delivery service system and method thereof will be described in greater detail with reference to the accompanying drawings.

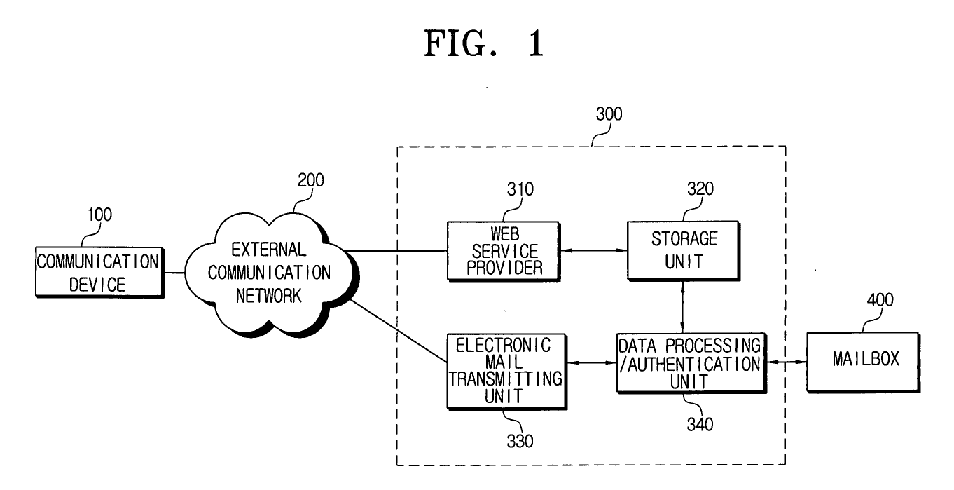

FIG. 1 illustrates the construction of a home delivery service system according to an embodiment of the present invention.

Referring to FIG. 1, a communication device 100 and a home gateway 300 are connected to an external communication network 200, respectively. A mailbox 400 is connected to, and communicates with the home gateway 300. The mailbox 400 has a compartment in which goods to be delivered/picked-up are kept. The compartment can be a separate parcel box positioned in the mailbox. The compartment is opened and closed in response to the control by the communication with the home gateway 300.

The home gateway 300 includes a web service provider 310, a storage unit 320, an electronic mail transmitting unit 330 and a data processing/authentication unit 340.

The web service provider 310 registers a password from the communication device 100 connected to the external communication network 200, together with an electronic mail address of the communication device 100. The storage unit 320 stores therein the registered information such as the password provided from the web service provider 310. The data processing/authentication unit 340 provides an interface for the communication with the mailbox 400, and processes data related to other necessary operations. The electronic mail transmitting unit 330 transmits an electronic mail to the registered electronic mail address provided through the external communication network 200.

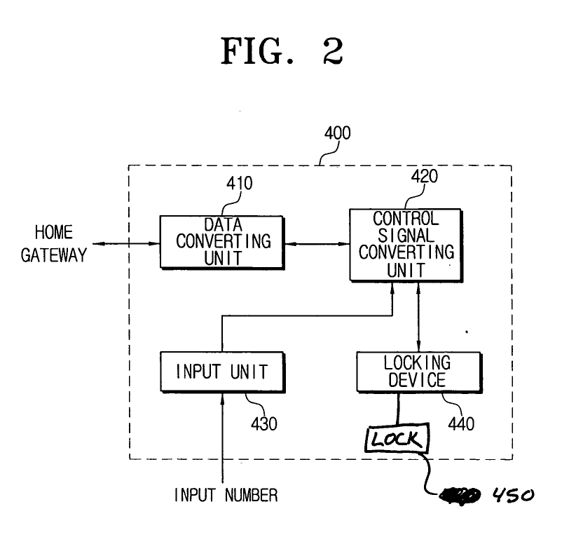

FIG. 2 is a block diagram of the mailbox 400 of FIG. 1. Referring to FIG. 2, the mailbox 400 includes a data converting unit 410, a control signal converting unit 420, an input unit 430, a locking device 440, and a lock 450.

The data converting unit 410 provides an interface for the communication with the home gateway 300. The input unit 430 receives an input number provided from a key input unit (not shown) formed in the body of the mailbox 400, and transmits the same to the control signal converting unit 420. The locking device 440 controls opening and closing of a lock 450 formed at a door of the mailbox, and transmits the information to the control signal converting unit 420 about the opening and closing status of the lock 450. The control signal converting unit 420 decrypts the signals between the input unit 430 and the locking device 440 on the one hand, and the data converting unit 410 on the other hand, and interfaces them.

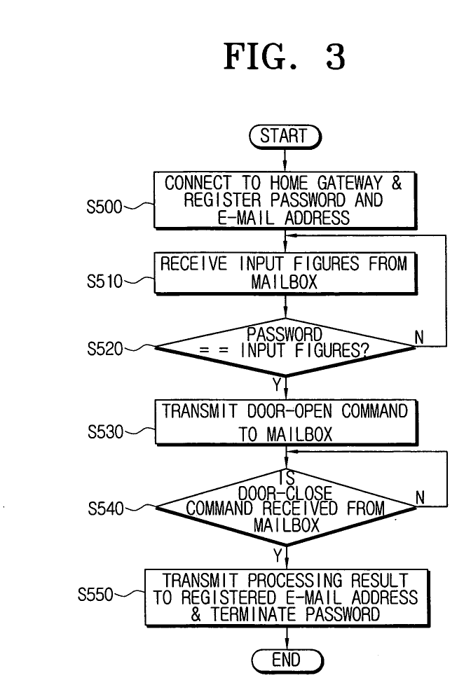

FIG. 3 is a flowchart illustrating the ordering process of the home delivery service system of FIG. 2.

Referring to FIG. 3, a customer communication device 100 connectible to the Web, connects to the home gateway 300 through the external communication network 200, and registers a password and electronic mail address (S500). The password input through the communication device 100 may be made by the customer and notified to the delivery company, or made by the deliver company and notified to the customer. The web service provider 310 of the home gateway 300 stores the information such as the password upon receiving it from the communication device 100.

When a serviceman of the delivery company arrives at the mailbox 400 at the address registered by the customer, the deliveryman inputs a predetermined set of figures through the key input device of the mailbox 400. The input figures are transmitted to the control signal converting unit 420 through the input unit 430, and the control signal converting unit 420 interprets and transmits it to the data converting unit 410. The data converting unit 410 converts the format of the received data into a predetermined transmittable data format and then transmits it to the data processing/authentication unit 340 of the home gateway 300.

The data processing/authentication unit 340 reads the input figures extracted from the data from the mailbox 400 (S510), compares the input figures with a pre-stored password and determines if they match (S520).

When it is determined at the data processing/authentication unit 340 that the input figures do not match with the pre-stored password, the system carries out no further operation and standbys until the input figures match the password. When the input figures match the password, the data processing/authentication unit 340 transmits a door-open command to the mailbox 400 (S530).

The door-open command from the home gateway 300 is transmitted to the data converting unit 410 of the mailbox 400, and the command is converted by the data converting unit 410 and transmitted to the control signal converting unit 420. The control signal converting unit 420 interprets the received data and transmits the unlock command to the locking device 440. According to the unlock command, the unlocking device 440 of the mailbox 400 opens the lock 450, and the serviceman of the delivery company picks up the parcel from the mailbox 400 which the parcel owner previously put, or deposits a parcel.

After the parcel is picked up (or dropped off), the door of the mailbox 400 is closed and the lock 450 locks, the locking device 440 transmits a door-close command to the control signal converting unit 420. The control signal converting unit 420 interprets and transmits the received door-close command to the data converting unit 410, and the data converting unit 410 transmits the door-close command to the data processing/authentication unit 340 of the home gateway 300.

The data processing/authentication unit 340 standbys until the door-close command is received from the mailbox 400 (S540), and when the door-close command is received, the data processing/authentication unit 340 controls the electronic mail transmitting unit 330 so that the electronic mail transmitting unit 330 transmits the result of the processing to the electronic mail address of the customer communication device 100 and terminates the password stored in the storage unit 320. With the above described system and method, the goods can be picked up even when there are no people inside the intended house.

Communication between the data processing/authentication unit 340 is possible by various methods, and particularly, the data processing/authentication unit 340 and the data converting unit 410 are connected through power line, so that they can perform power line communication (PLC). The power line communication sends and receives data in the frequency bandwidth of 1-30 Mhz, which is higher than the normal frequency bandwidth approximately of 60 Hz necessary for simple power transmission and reception.

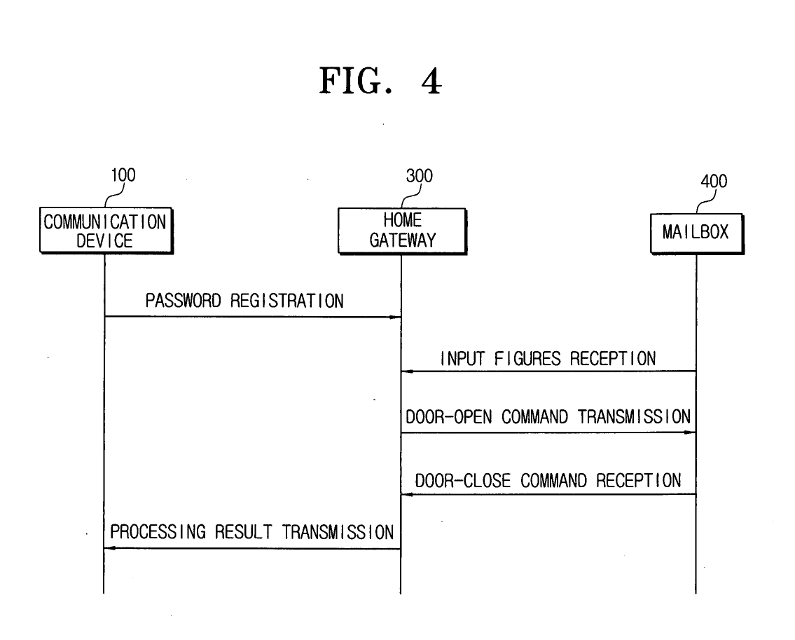

FIG. 4 is a view schematically showing the flow of data signals between the communication device 100, the home gateway 300 and the mailbox 400.

As described above, the communication device 100 registers a password in the home gateway 300, and the home gateway 300 receives input figures from the mailbox 400. When the input figures match the preset password, the home gateway 300 transmits a door-open command to the mailbox 400. After the door is opened and the parcel is taken out or delivered, the mailbox 400 sends out a door-close command to the home gateway 300. Accordingly, the home gateway 300 transmits the result of the processing to the communication device 100 and terminates the password.

While an embodiment of the present invention has been described with reference to a case where a customer orders for a home delivery service, this is just by way of example, and the home deliver/pick-up service system according to the present invention can be applied to various ways. For example, for a delivery of a small-sized parcel, the deliveryman calls the intended receiver and is notified of the receiver's password. The deliveryman inputs the receiver-made password in the mailbox, puts the parcel in the mailbox and closes the door. With the closing of the door, the completion of the delivery is notified to the communication device of the receiver.

According to the present invention, home delivery can be made more conveniently, because the parcel can be safely received to the intended receiver even when the receiver is not in the intended place. This speeds up the delivery and is good for both the delivery company and the receiver.

Although a few embodiments of the present invention have been described, it will be understood by those skilled in the art that the present invention should not be limited to the described embodiments, but various changes and modifications can be made within the spirit and scope of the present invention as defined by the appended claims.

What is claimed is:

1. A home delivery service system, said system comprising:
a mailbox having a lock to lock said mailbox;
an external device in communication with said mailbox which controls opening and closing of said lock in accordance with a signal received from the external device;
a key input unit in communication with said external device such that a set of figures can be input into said key input unit and said figures are transmitted to said external device;
a web service provider in communication with an external communication network, and having registered therein a password transmitted from a communication device in communication with the external communication network;
a storage unit for storing the password; and
a data processing/authentication unit in communication with the mailbox, and when the set of input figures transmitted to the mailbox match the password stored in the storage unit said data processing/authentication unit transmits an open-signal to the mailbox.

2. The home delivery service system of claim 1, further comprising an electronic mail transmitting unit which sends out a first electronic mail to the communication device based on a response signal from the mailbox.

3. The home delivery service system of claim 2, wherein the lock is opened in accordance with the open-signal.

4. The home delivery service system of claim 3, wherein when the lock is closed, the mailbox transmits a close-signal to the data processing/authentication unit, and the data processing/authentication unit controls the electronic mail transmitting unit in accordance with the close-signal as received so that a second electronic mail is sent out to the communication device.

5. The home delivery service system of claim 4, wherein the mailbox comprises:
a data converting unit which communicates with the data processing/authentication unit;
a locking device which controls the opening and closing of the lock;
an input unit which receives the set of figures; and
a control signal converting unit which interprets and interfaces signals between the locking device and the input unit, and the locking device and the data converting unit.

6. The home delivery service system of claim 1, wherein the mailbox and the data processing/authentication unit are connected through a power line, to carry out a power line communication.

7. A home delivery service method, comprising the steps of:
placing a mailbox having a lock in communication with an external device;
transmitting a password from a communication device to an external communication network;
storing said password;
inputting a set of figures into an input unit in communication with said mailbox;
comparing said figures to said password; and
transmitting an open-signal to said mailbox if said set of figures matches said password.

8. The home delivery service method of claim 7, further comprising the step of sending out a first electronic mail to the communication device based on a response signal from the mailbox.

9. The home delivery service method of claim 8, wherein the lock is un-locked in response to the open-signal.

10. The home delivery service method of claim 9, wherein, when the lock is closed, a second electronic mail is sent out to the communication device to inform that the lock is locked.

11. The home delivery service method of claim 7, wherein said external device transmits said open-signal to said mailbox.

12. The home delivery service method of claim 7, wherein said external device compares said set of figures and said password.

13. The home delivery service method of claim 7, further comprising opening said mailbox and depositing a parcel in said mailbox after said open-signal is transmitted.

14. The home delivery service method of claim 7, further comprising opening said mailbox and removing a parcel from said mailbox after said open-signal is transmitted.

15. The home delivery service system of claim 1, wherein said external device is a home gateway.

16. The home delivery service system of claim 1, wherein said external device comprises said storage unit.

17. The home delivery service system of claim 1, wherein said external devices stores an electronic mail address of said communication device.
